(19) United States
(12) Patent Application Publication
(10) Pub. No.: US 2022/0393623 A1
(43) Pub. Date: Dec. 8, 2022

(54) DRIVE CIRCUIT OF BRIDGE CIRCUIT, MOTOR DRIVE APPARATUS WITH DRIVE CIRCUIT, AND ELECTRONIC DEVICE

(71) Applicant: ROHM Co., LTD., Kyoto (JP)

(72) Inventor: Hisashi SUGIE, Kyoto (JP)

(21) Appl. No.: 17/831,832

(22) Filed: Jun. 3, 2022

(30) Foreign Application Priority Data
Jun. 7, 2021 (JP) 2021-095454

(51) Int. Cl. H02P 6/08; H02P 27/08; H02K 11/33

(52) U.S. Cl. CPC H02P 6/085; H02P 27/08; H02K 11/33

(57) ABSTRACT

A drive circuit that drives a bridge circuit including a high side transistor and a low side transistor includes an output sensor that generates an output monitor signal for indicating that an output voltage of the bridge circuit has transitioned to high or transitioned to low, a correction circuit that receives the output monitor signal and an input signal for giving an instruction for output of the bridge circuit and generates a real drive signal, a high side driver circuit that drives the high side transistor according to a high side control signal based on the real drive signal, and a low side driver circuit that drives the low side transistor according to a low side control signal based on the real drive signal. The correction circuit measures a first time period and a second time period and changes the real drive signal to an on-level or an off-level.

### CROSS REFERENCE TO RELATED APPLICATIONS

This application claims priority benefit of Japanese Patent Application No. JP 2021-095454 filed in the Japan Patent Office on Jun. 7, 2021. Each of the above-referenced applications is hereby incorporated herein by reference in its entirety.

### BACKGROUND

The present disclosure relates to a drive circuit of a bridge circuit.

Half bridge circuits, H-bridge circuits, and three-phase bridge circuits (hereinafter, collectively referred to as bridge circuits) with power transistors are often used in, for example, motor driver circuits, direct current to direct current (DC/DC) converters, and power conversion apparatuses.

The bridge circuit includes an upper arm and a lower arm provided in series between a power supply terminal and a ground terminal. The upper arm includes a high side transistor and a flywheel diode connected to each other in parallel. The lower arm includes a low side transistor and a flywheel diode connected to each other in parallel.

The bridge circuit can be switched between a high output state in which the high side transistor is on and the low side transistor is off and a low output state in which the high side transistor is off and the low side transistor is on. An undesirable through current flows if the high side transistor and the low side transistor are turned on at the same time in the transition between the high output state and the low output state. To prevent this, the bridge circuit provides a high impedance state in which both the high side transistor and the low side transistor are turned off in the transition between the high output state and the low output state. A period in which the bridge circuit enters the high impedance state will be referred to as dead time.

Pulse width modulation (PWM) control of the bridge circuit will be examined. Ideally, an effective output voltage (time average) V_{OUT} of the bridge circuit is

V_{OUT}=V_{IN}×d (1)

where d (0≤d≤1) represents a command value of the duty cycle of a PWM signal. V_{IN} represents an input voltage of the bridge circuit.

However, the effective output voltage V_{OUT} of the bridge circuit is deviated from the value of Equation (1) when the dead time is inserted. A technique for correcting an error of the effective value of the output voltage V_{OUT} caused by the dead time is disclosed in Japanese Patent Laid-Open No. 2019-204997.

### SUMMARY

The present disclosure has been made in view of the circumstances, and it is desirable to provide a drive circuit that can correct influence of dead time.

An example of the present disclosure relates to a drive circuit that drives a bridge circuit including a high side transistor connected between a power line and an output line and a low side transistor connected between the output line and a ground line. The drive circuit includes an output sensor that generates an output monitor signal for indicating that an output voltage of the bridge circuit has transitioned to high or low, a correction circuit that receives the output monitor signal and an input signal for giving an instruction for output of the bridge circuit and generates a real drive signal, a high side driver circuit that drives the high side transistor according to a high side control signal based on the real drive signal, and a low side driver circuit that drives the low side transistor according to a low side control signal based on the real drive signal. The correction circuit measures a first time period that is a time period from a transition of the real drive signal to an on-level to a time when the output monitor signal indicates a transition of the output voltage to high, measures a second time period that is a time period from a transition of the real drive signal to an off-level to a time when the output monitor signal indicates a transition of the output voltage to low, changes, in a cycle, the real drive signal to the on-level after the second time period that is measured in a previous cycle has elapsed since a transition of the input signal to an on-level, and changes the real drive signal to the off-level after the first time period that is measured in the same cycle has elapsed since a transition of the input signal to an off-level.

Note that any combination of the abovementioned constituent elements as well as constituent elements and expressions obtained by exchanging the constituent elements and the expressions among methods, apparatuses, and systems are also effective as examples of the present technology.

According to the example of the present disclosure, the influence of the dead time can be corrected.

### BRIEF DESCRIPTION OF THE DRAWINGS

FIG. 1 is a circuit diagram of a switching circuit according to an embodiment;

FIG. 2 is a diagram describing an operation of the switching circuit in FIG. 1;

FIG. 3 is a block diagram illustrating a configuration example of a correction circuit;

FIG. 4 is a circuit diagram illustrating a specific configuration example of the correction circuit;

FIG. 5 is an operation waveform diagram of the correction circuit in FIG. 4;

FIG. 6 is a circuit diagram of a specific configuration example of a timer circuit;

FIG. 7 is a circuit diagram of a specific configuration example of a timer circuit;

FIG. 8 is a circuit diagram illustrating a configuration example of a high side driver circuit; and

FIG. 9 is a circuit diagram of a motor drive apparatus including the switching circuit according to the embodiment.

### DETAILED DESCRIPTION OF THE PREFERRED EMBODIMENTS

### Overview of Embodiments

An overview of some exemplary embodiments of the present disclosure will be described. The overview simply describes some concepts of one or a plurality of embodiments for basic understanding of the embodiments as a preface to detailed explanation described later, and the overview does not limit the extent of the technology or the disclosure. For convenience, “one embodiment” may be used to indicate one embodiment (example or modification) or a plurality of embodiments (examples or modifications) disclosed in the present specification.

The overview is not a comprehensive overview of all conceivable embodiments, and the overview is not intended to specify important elements of all the embodiments or to define the scope of part or all of the examples. The sole purpose of the overview is to present a simplified form of some concepts of one or a plurality of embodiments as a preface to more detailed explanation presented later.

An embodiment provides a drive circuit that drives a bridge circuit including a high side transistor connected between a power line and an output line and a low side transistor connected between the output line and a ground line. The drive circuit includes an output sensor, a correction circuit, a high side driver circuit, and a low side driver circuit. The output sensor generates an output monitor signal for indicating that an output voltage of the bridge circuit has transitioned to high or low. The correction circuit receives the output monitor signal and an input signal for giving an instruction for output of the bridge circuit and generates a real drive signal. The high side driver circuit drives the high side transistor according to a high side control signal based on the real drive signal. The low side driver circuit drives the low side transistor according to a low side control signal based on the real drive signal. The correction circuit measures a first time period that is a time period from the transition of the real drive signal to an on-level to the time when the output monitor signal indicates the transition of the output voltage to high, and measures a second time period that is a time period from the transition of the real drive signal to an off-level to the time when the output monitor signal indicates the transition of the output voltage to low. Further, the correction circuit changes, in a cycle, the real drive signal to the on-level after the second time period, which is measured in a previous cycle, has elapsed since the transition of the input signal to an on-level, and changes the real drive signal to the off-level after the first time period, which is measured in the same cycle, has elapsed since the transition of the input signal to an off-level.

According to the configuration, the delay in the rise of the output voltage is corrected in the fall of the next output voltage, and the delay in the fall of the output voltage is corrected in the rise of the next output voltage. Thus, the influence of the dead time can be corrected.

In the embodiment, the correction circuit may include a first timer circuit that measures the first time period and a second timer circuit that measures the second time period. Two timer circuits can alternately be used to correct the rise and the fall of the output voltage.

In the embodiment, the first timer circuit may include a first capacitor, a first charge circuit that charges the first capacitor with a constant current, a first discharge circuit that discharges the first capacitor with the same amount of constant current as the first charge circuit, and a first comparison circuit that compares a voltage of the first capacitor and a first threshold voltage corresponding to an initial voltage of the first capacitor to generate a turn-off trigger. The first charge circuit is enabled when the real drive signal transitions to the on-level, and is disabled when the output monitor signal indicates the transition of the output voltage to high. The first discharge circuit is enabled when the input signal transitions to the off-level. The correction circuit may change the real drive signal to the off-level in response to the turn-off trigger. The first charge circuit can charge the first capacitor to raise the voltage of the first capacitor, and the amount of rise in the voltage can be sampled as the first time period. The first discharge circuit can discharge the first capacitor to reduce the voltage of the first capacitor to the original initial voltage. In this way, the same time period as the most recently sampled first time period can be measured.

In the embodiment, the second timer circuit may include a second capacitor, a second charge circuit that charges the second capacitor with a constant current, a second discharge circuit that discharges the second capacitor with the same amount of constant current as the second charge circuit, and a second comparison circuit that compares a voltage of the second capacitor and a second threshold voltage corresponding to an initial voltage of the second capacitor to generate a turn-on trigger. The second charge circuit is enabled when the real drive signal transitions to the off-level, and is disabled when the output monitor signal indicates the transition of the output voltage to low. The second discharge circuit is enabled when the input signal transitions to the on-level. The correction circuit may change the real drive signal to the on-level in response to the turn-on trigger. The second charge circuit can charge the second capacitor to raise the voltage of the second capacitor, and the amount of rise in the voltage can be sampled as the second time period. The second discharge circuit can discharge the second capacitor to reduce the voltage of the second capacitor to the original initial voltage. In this way, the same time period as the most recently sampled second time period can be measured.

In the embodiment, the first comparison circuit may include a first impedance element provided on a path of the constant current generated by the first charge circuit, and a first voltage comparator. The first timer circuit may apply, prior to start of timer operation, the initial voltage based on a voltage drop of the impedance element to the first capacitor, and the first voltage comparator may compare the voltage of the first capacitor and the threshold voltage based on the voltage drop of the first impedance element.

In the embodiment, the first voltage comparator may be able to adjust an input offset voltage. This can cancel the influence of the propagation delay according to the input offset voltage.

The first comparison circuit may include a first field-effect transistor having a gate connected to the first capacitor, and a second field-effect transistor that is of the same type as the first field-effect transistor and that has a gate and a drain connected to each other. Prior to the start of the timer operation, the timer circuit may apply, to the first capacitor, the initial voltage based on a voltage drop of the second field-effect transistor in a state in which the constant current generated by the first charge circuit flows to the second field-effect transistor.

The high side driver circuit may be configured to supply a predetermined amount of on-current to a gate of the high side transistor when the high side control signal is in an on-level, and may be configured to sink the predetermined amount of off-current from the gate of the high side transistor when the high side control signal is in an off-level.

### Embodiment

A preferred embodiment will now be described with reference to the drawings. The same reference signs are provided to the same or equivalent constituent elements, members, and processes illustrated in the drawings, and duplicate description will appropriately be omitted. The embodiment is exemplary and is not intended to limit the technology. All features and combinations of the features described in the embodiment may not be essential for the technology.

In the present specification, “a state in which a member A is connected to a member B” includes a case in which the member A and the member B are physically and directly connected to each other, as well as a case in which the member A and the member B are indirectly connected to each other through another member that does not substantially affect their electrical connection state or that does not impair the functions and the effects obtained by coupling them.

Similarly, “a state in which a member C is provided between a member A and a member B” includes a case in which the member A and the member C or the member B and the member C are directly connected to each other, as well as a case in which they are indirectly connected to each other through another member that does not substantially affect their electrical connection state or that does not impair the functions and the effects obtained by coupling them.

Note that vertical axes and horizontal axes of waveform diagrams and time charts referenced in the present specification are appropriately scaled up and down to facilitate the understanding, and each illustrated waveform is also simplified, exaggerated, or emphasized to facilitate the understanding.

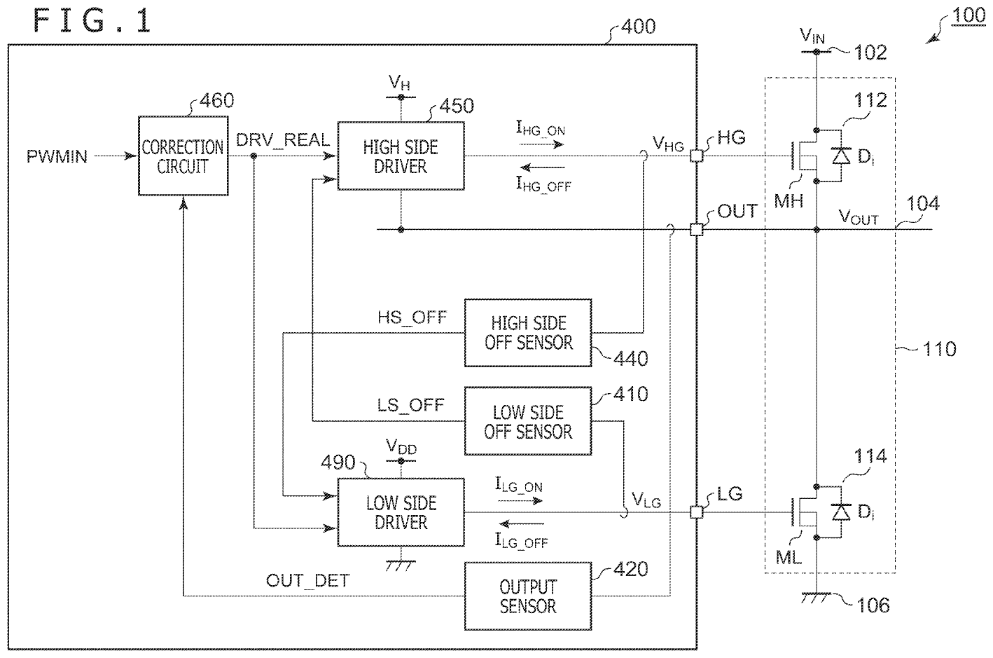

FIG. 1 is a circuit diagram of a switching circuit 100 according to the embodiment. The switching circuit 100 includes a bridge circuit 110 and a drive circuit 400. Although a configuration of one phase of the switching circuit 100 is illustrated here, the switching circuit 100 may be a three-phase switching circuit or an H-bridge circuit.

The bridge circuit 110 includes an upper arm 112 provided between an input line (power line) 102 and an output terminal (output line) 104 and a lower arm 114 provided between the output line 104 and a ground line 106. The upper arm 112 includes a high side transistor MH and a flywheel diode (freewheel diode) Di connected to each other in parallel. The lower arm 114 includes a low side transistor ML and a flywheel diode Di connected to each other in parallel. In the present embodiment, the high side transistor MH and the low side transistor ML are N-channel metal oxide semiconductor field effect transistors (MOSFETs), and a body diode of each transistor serves as the flywheel diode Di.

The drive circuit 400 controls the upper arm 112 and the lower arm 114 of the bridge circuit 110. The drive circuit 400 switches the bridge circuit 110 between two states including a high output state φ_{H} in which the upper arm 112 is on and the lower arm 114 is off and a low output state φ_{L} in which the upper arm 112 is off and the lower arm 114 is on. The bridge circuit 110 may also enter a high impedance state φ_{HZ} in which both the upper arm 112 and the lower arm 114 are off.

The drive circuit 400 includes three sensors 410, 420, and 440, a high side driver circuit 450, a correction circuit 460, and a low side driver circuit 490, and the drive circuit 400 is a functional integrated circuit (IC) integrated into one semiconductor substrate.

A first sensor is the low side off sensor 410 that generates a low side off signal LS_OFF asserted when the low side transistor ML is turned off. The low side off sensor 410 asserts the low side off signal LS_OFF when, for example, a gate-source voltage (gate voltage) of the low side transistor ML falls below a first threshold voltage V_{TH1} set according to a threshold voltage of the MOSFET.

A second sensor is the high side off sensor 440 that generates a high side off signal HS_OFF asserted when the high side transistor MH is turned off. The high side off sensor 440 asserts the high side off signal HS_OFF when, for example, a gate-source voltage of the high side transistor MH falls below a fourth threshold voltage V_{TH4} set according to the threshold voltage of the MOSFET.

A third sensor is the output sensor 420 that generates an output monitor signal OUT_DET indicating that an output voltage V_{OUT} of the bridge circuit 110 has transitioned to high or transitioned to low. For example, the output sensor 420 may compare the output voltage V_{OUT} with a predetermined threshold voltage V_{TH} (for example, V_{IN}/2). When the output voltage V_{OUT} exceeds the threshold voltage V_{TH}, the output sensor 420 may determine that the output voltage V_{OUT} has transitioned to high, and when the output voltage V_{OUT} becomes lower than the threshold voltage V_{TH}, the output sensor 420 may determine that the output voltage V_{OUT} has transitioned to low.

Alternatively, the output sensor 420 may compare the output voltage V_{OUT} with two threshold voltages V_{THH} and V_{THL}. When the output voltage V_{OUT} exceeds the threshold voltage V_{THH}, the output sensor 420 may determine that the output voltage V_{OUT} has transitioned to high, and when the output voltage V_{OUT} becomes lower than the threshold voltage V_{THL}, the output sensor 420 may determine that the output voltage V_{OUT} has transitioned to low. V_{THH}>V_{IN}/2>V_{THL} may be satisfied. In this case, the output monitor signal OUT_DET may include a high detection signal based on the comparison result of V_{OUT} and V_{THH} and a low detection signal based on the comparison result of V_{OUT} and V_{THL}.

The correction circuit 460 receives an input signal PWMIN generated by a controller not illustrated and the output monitor signal OUT_DET to generate a real drive signal DRV_REAL.

The high side driver circuit 450 receives the real drive signal DRV_REAL and the low side off signal LS_OFF. An output node of the high side driver circuit 450 is connected to a gate of the high side transistor MH.

The high side driver circuit 450 drives the high side transistor MH according to a high side control signal HGCTL based on the real drive signal DRV_REAL. The high side control signal HGCTL that is an internal signal of the high side driver circuit 450 is in an on-level when the real drive signal DRV_REAL is in an on-level (for example, high) and the low side off signal LS_OFF is asserted. Further, the high side control signal HGCTL is in an off-level when the real drive signal DRV_REAL is in an off-level.

The high side driver circuit 450 turns on the high side transistor MH when the high side control signal HGCTL is in the on-level, and turns off the high side transistor MH when the high side control signal HGCTL is in the off-level.

Specifically, the high side driver circuit 450 is configured to supply a predetermined amount of on-current I_{HG_ON} to the gate of the high side transistor MH when the high side control signal HGCTL is in the on-level (the real drive signal DRV_REAL is in the on-level and the low side off signal LS_OFF is asserted). This raises a gate-source voltage V_{GS} of the high side transistor MH at a constant slope and turns on the high side transistor MH.

Further, the high side driver circuit 450 is configured to sink an off-current I_{HG_OFF} from the gate of the high side transistor MH when the high side control signal HGCTL is in the off-level (low) (the real drive signal DRV_REAL is in the off-level). This reduces the gate-source voltage V_{GS} of the high side transistor MH at a constant slope and turns off the high side transistor MH.

The amount of off-current I_{HG_OFF} and the amount of on-current I_{HG_ON} may be the same here. This guarantees that a turn-on time period and a turn-off time period of the high side transistor MH are equal. Note that the amount of off-current I_{HG_OFF} and the amount of on-current I_{HG_ON} may be different.

The configuration of the low side driver circuit 490 is similar to the configuration of the high side driver circuit 450. The low side driver circuit 490 receives the real drive signal DRV_REAL and the high side off signal HS_OFF. An output node of the low side driver circuit 490 is connected to a gate of the low side transistor ML.

The low side driver circuit 490 drives the low side transistor ML according to a low side control signal LGCTL based on the real drive signal DRV_REAL. The low side control signal LGCTL that is an internal signal of the low side driver circuit 490 is in an on-level (for example, high) when the real drive signal DRV_REAL is in the off-level and the high side off signal HS_OFF is asserted. Further, the low side control signal LGCTL is in an off-level (for example, low) when the real drive signal DRV_REAL is in the on-level.

The low side driver circuit 490 turns on the low side transistor ML when the low side control signal LGCTL is in the on-level, and turns off the low side transistor ML when the low side control signal LGCTL is in the off-level.

Specifically, the low side driver circuit 490 supplies a predetermined amount of on-current I_{LG_ON} to the gate of the low side transistor ML when the low side control signal LGCTL is in the on-level (the real drive signal DRV_REAL is in the off-level and the high side off signal HS_OFF is asserted). This raises a gate-source voltage V_{GS} of the low side transistor ML at a constant slope and turns on the low side transistor ML.

The low side driver circuit 490 is configured to sink an off-current I_{LG_OFF} from the gate of the low side transistor ML when the low side control signal LGCTL is in the off-level (the real drive signal DRV_REAL is in the on-level). This reduces the gate-source voltage V_{GS} of the low side transistor ML at a constant slope and turns off the low side transistor ML.

The amount of off-current I_{LG_OFF} and the amount of on-current I_{LG_ON} may be the same here. This guarantees that a turn-on time period and a turn-off time period of the low side transistor ML are equal. Note that the amount of off-current I_{LG_OFF} and the amount of on-current I_{LG_ON} may be different.

The correction circuit 460 receives the input signal PWMIN and the output monitor signal OUT_DET to generate the real drive signal DRV_REAL.

The correction circuit 460 measures a first time period τ₁ that is a time period from the transition of the real drive signal DRV_REAL, which is the output of the correction circuit 460, to the on-level to the time when the output monitor signal OUT_DET indicates the transition of the output voltage V_{OUT} to high.

The correction circuit 460 measures a second time period τ₂ that is a time period from the transition of the real drive signal DRV_REAL, which is the output of the correction circuit 460, to the off-level to the time when the output monitor signal OUT_DET indicates the transition of the output voltage V_{OUT} to low.

The correction circuit 460 changes, in a cycle, the real drive signal DRV_REAL to the on-level after the second time period τ₂, which is measured in the previous cycle, has elapsed since the transition of the input signal PWMIN to the on-level. Further, the correction circuit 460 changes the real drive signal DRV_REAL to the off-level after the first time period τ₁, which is measured in the same cycle, has elapsed since the transition of the input signal PWMIN to the off-level.

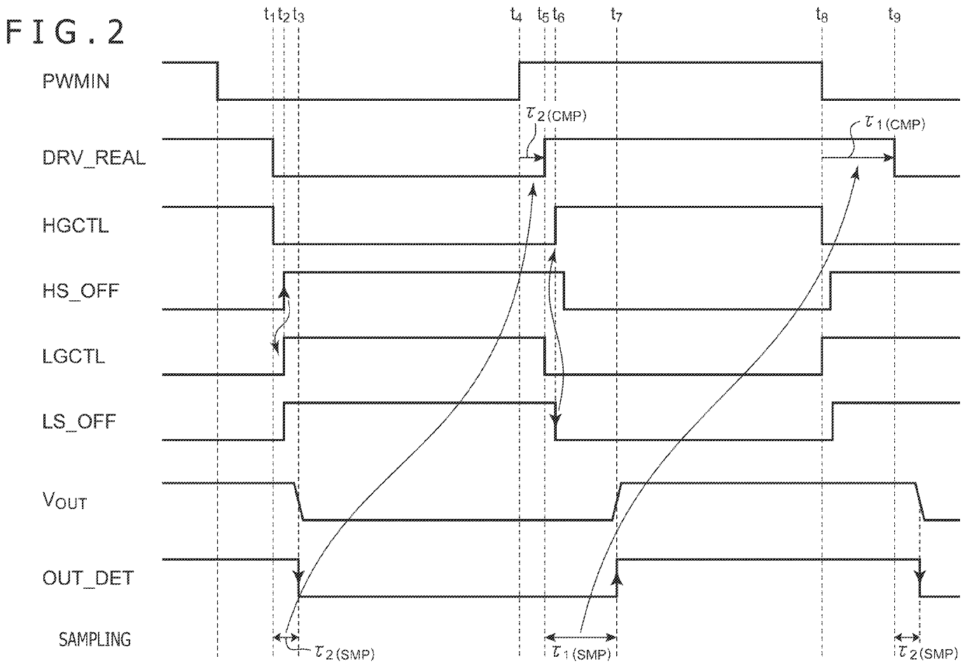

The configuration of the switching circuit 100 has been described. Next, an operation of the switching circuit 100 will be described. FIG. 2 is a diagram describing the operation of the switching circuit 100 in FIG. 1.

Once the real drive signal DRV_REAL has transitioned to the off-level (low) at time t₁, the high side control signal HGCTL becomes low, and the high side driver circuit 450 reduces a gate voltage V_{HG} of the high side transistor MH to turn off the high side transistor MH. Once the high side transistor MH is turned off at time t₂, the high side off signal HS_OFF is asserted. Once the high side off signal HS_OFF is asserted, the low side control signal LGCTL becomes high, and the low side driver circuit 490 raises the gate voltage V_{LG} of the low side transistor ML to turn on the low side transistor ML. Once the low side transistor ML is turned on, the output voltage V_{OUT} transitions to the low level (0 V), and the output monitor signal OUT_DET indicates the transition to low at time t₃.

The correction circuit 460 measures (samples) a second time period τ_{2(SMP)} that is a time period from time t₁ at which the real drive signal DRV_REAL as the output of the correction circuit 460 has transitioned to the off-level, to time t₃ at which the output monitor signal OUT_DET indicates the transition of the output voltage V_{OUT} to low.

The input signal PWMIN transitions to an on-level at time t₄. The correction circuit 460 changes the real drive signal DRV_REAL to the on-level at time t₅ that is time after a second correction time period τ_{2(CMP)}, which is based on the second time period τ_{2(SMP)} measured in the previous cycle, has elapsed since the transition of the input signal PWMIN to the on-level.

Once the real drive signal DRV_REAL transitions to the on-level (high) at time t₅, the low side control signal LGCTL becomes low, and the low side driver circuit 490 reduces the gate voltage V_{LG} of the low side transistor ML to turn off the low side transistor ML. Once the low side transistor ML is turned off at time t₆, the low side off signal LS_OFF is asserted. Once the low side off signal LS_OFF is asserted, the high side control signal HGCTL becomes high, and the high side driver circuit 450 raises the gate voltage V_{HG} of the high side transistor MH to turn on the high side transistor MH. Once the high side transistor MH is turned on, the output voltage V_{OUT} transitions to the high level (V_{IN}), and the output monitor signal OUT_DET indicates high at time t₇.

The correction circuit 460 measures (samples) a first time period τ_{1(SMP)} that is a time period from time t₅ at which the real drive signal DRV_REAL as the output of the correction circuit 460 has transitioned to the on-level, to time t₇ at which the output monitor signal OUT_DET indicates the transition of the output voltage V_{OUT} to high.

The input signal PWMIN transitions to an off-level at time t₈. The correction circuit 460 changes the real drive signal DRV_REAL to the off-level at time t₉ that is time after a first correction time period τ_{1(CMP)}, which is based on the first time period τ_{1(SMP)} measured in the same cycle, has elapsed since time t₈ at which the input signal PWMIN has transitioned to the off-level.

The drive circuit 400 repeats the operation of time t₁ to time t₉. The operation of the drive circuit 400 has been described.

According to the drive circuit 400, the pulse width of the output voltage V_{OUT}, that is, the duty cycle, is equal to the pulse width (that is, the duty cycle) of the input signal PWMIN. Therefore, the influence of the dead time can be corrected.

Next, a specific configuration example of the drive circuit 400 will be described.

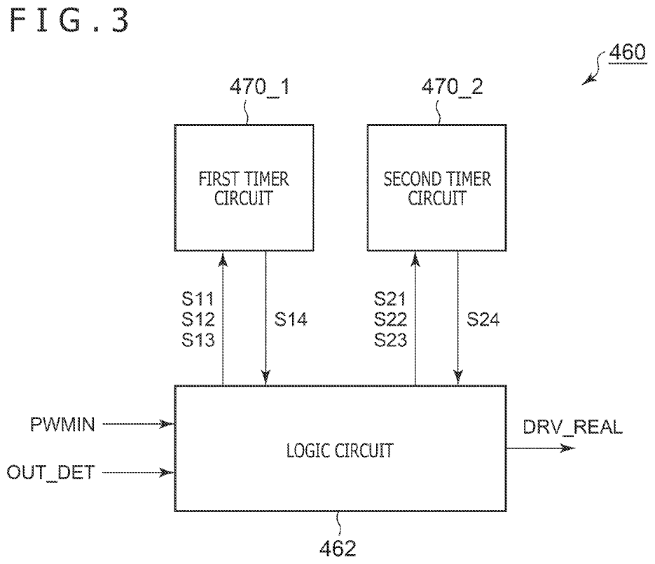

FIG. 3 is a block diagram illustrating a configuration example of the correction circuit 460. The correction circuit 460 includes an event-driven logic circuit 462 and timer circuits 470_1 and 470_2.

The timer circuits 470_1 and 470_2 are controlled by the logic circuit 462. The first timer circuit 470_1 is used to manage the first time period τ₁. The first timer circuit 470_1 starts the measurement of the time period in response to a sampling start signal S11 and stops the measurement of the time period in response to a sampling end signal S12. The first timer circuit 470_1 holds the sampled first time period τ_{1(SMP)}. Further, the first timer circuit 470_1 starts the measurement of the time period in response to a correction start signal S13 and asserts a correction end signal S14 after the first time period τ_{1(SMP)} has elapsed.

The second timer circuit 470_2 is used to manage the second time period τ₂. The second timer circuit 470_2 starts the measurement of the time period in response to a sampling start signal S21 and stops the measurement of the time period in response to a sampling end signal S22. The second timer circuit 470_2 holds the sampled second time period τ_{2(SMP)}. Further, the second timer circuit 470_2 starts the measurement of the time period in response to a correction start signal S23 and asserts a correction end signal S24 after the second time period τ_{2(SMP)} has elapsed.

In addition to the input signal PWMIN, the output monitor signal OUT_DET is input to the logic circuit 462.

The logic circuit 462 is triggered by the transition of the real drive signal DRV_REAL to the off-level to output the sampling start signal S21 to the second timer circuit 470_2. The logic circuit 462 outputs the sampling end signal S22 when the output monitor signal OUT_DET indicates that the output voltage V_{OUT} has changed to low.

The logic circuit 462 is triggered by the transition of the input signal PWM_IN to the on-level to output the correction start signal S23 to the second timer circuit 470_2. The logic circuit 462 causes the real drive signal DRV_REAL to transition to the on-level when the logic circuit 462 receives the correction end signal S24 from the second timer circuit 470_2.

The logic circuit 462 is triggered by the transition of the real drive signal DRV_REAL to the on-level to output the sampling start signal S11 to the first timer circuit 470_1. The logic circuit 462 outputs the sampling end signal S12 when the output monitor signal OUT_DET indicates that the output voltage V_{OUT} has changed to high.

The logic circuit 462 is triggered by the transition of the input signal PWM_IN to the off-level to output the correction start signal S13 to the first timer circuit 470_1. The logic circuit 462 causes the real drive signal DRV_REAL to transition to the off-level when the logic circuit 462 receives the correction end signal S14 from the first timer circuit 470_1.

The configuration of the timer circuit 470 is not limited to a particular configuration. The timer circuit 470 may have a configuration of an analog timer or may have a configuration of a digital timer (counter).

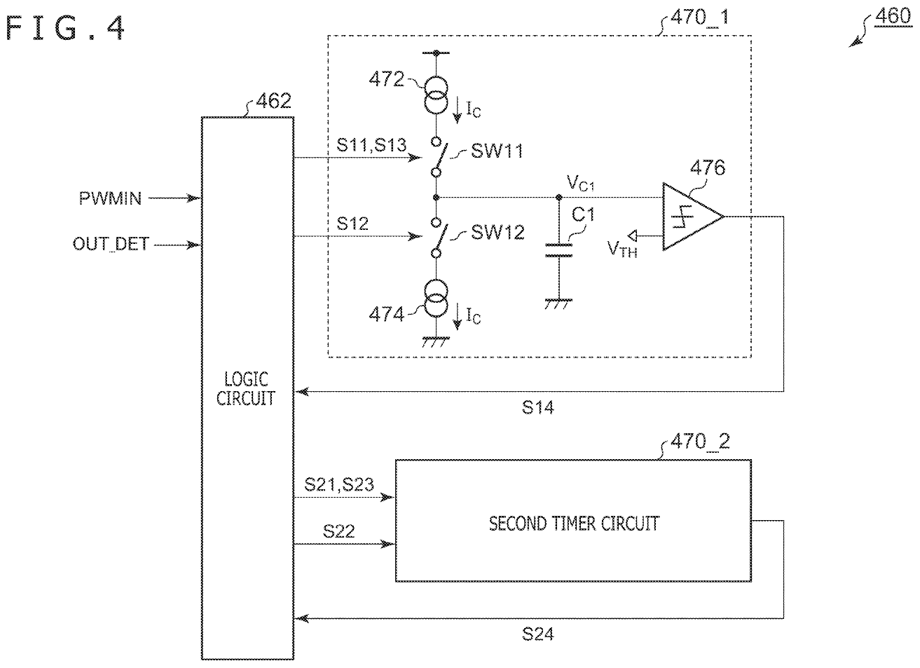

FIG. 4 is a circuit diagram illustrating a specific configuration example of the correction circuit 460. The first timer circuit 470_1 and the second timer circuit 470_2 are analog timers. The first timer circuit 470_1 includes a capacitor C1, a charge circuit 472, a discharge circuit 474, and a comparison circuit 476. An initial voltage V_{INIT} is applied to the capacitor C1 prior to sampling, and the charge is initialized.

The logic circuit 462 uses the sampling start signal S11 to turn on a switch SW11 to enable the charge circuit 472. The logic circuit 462 uses the sampling end signal S12 to turn off the switch SW11 to disable the charge circuit 472. While the charge circuit 472 is enabled, the charge circuit 472 charges the capacitor C1 with a constant current Ic. A voltage V_{C1} of the capacitor C1 at the end of sampling is

V_{SMP}=V_{INIT}+T_{SMP}×Ic/C1

where T_{SMP} represents the length of the charge period. T_{SMP} represents the first time period τ₁.

The logic circuit 462 uses the correction start signal S13 to turn on a switch SW12 to enable the discharge circuit 474 and start the timer. During the timer operation of the timer circuit 470_1, the voltage V_{C1} of the capacitor C1 drops at a slope of Ic/C1.

The comparison circuit 476 compares the voltage V_{C1} of the capacitor C1 and the threshold voltage V_{TH} corresponding to the initial voltage V_{INIT}. The comparison circuit 476 outputs the correction end signal S14 once the voltage V_{C1} drops to the voltage V_{TH}.

The configuration of the second timer circuit 470_2 is similar to the configuration of the first timer circuit 470_1. The second timer circuit 470_2 samples the second time period τ_{2(SMP)} and uses the timer to count the sampled time period τ_{2(SMP)}.

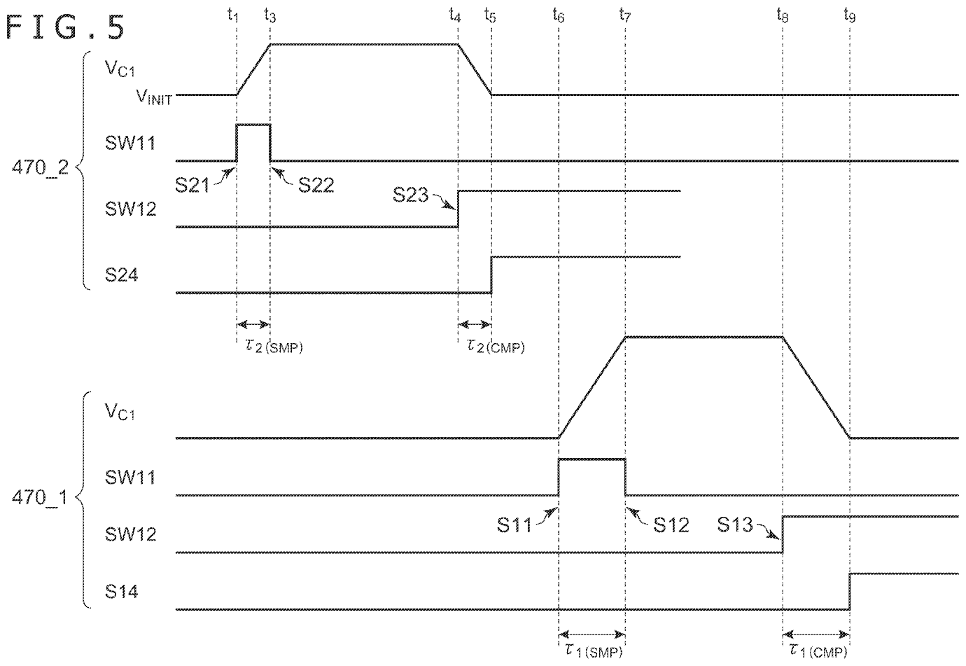

FIG. 5 is an operation waveform diagram of the correction circuit 460 in FIG. 4. The time illustrated in FIG. 5 corresponds to the time illustrated in FIG. 2.

An upper part of FIG. 5 illustrates an operation of the second timer circuit 470_2. Once the sampling start signal S21 is asserted at time t₁, the switch SW11 of the second timer circuit 470_2 is turned on, and the voltage V_{C1} of the capacitor C1 rises. Once the sampling end signal S22 is asserted at time t₂, the switch SW11 is turned off, and the rise of the voltage V_{C1} stops.

Once the correction start signal S23 is asserted at time t₄, the switch SW22 is turned on, and the voltage V_{C1} of the capacitor C1 drops. The correction end signal S24 is asserted after the second correction time period τ_{2(CMP)} equal to the second time period τ_{2(SMP)} has elapsed.

A lower part of FIG. 5 illustrates an operation of the first timer circuit 470_1. Once the sampling start signal S11 is asserted at time t₆, the switch SW11 of the first timer circuit 470_1 is turned on, and the voltage V_{C1} of the capacitor C1 rises. Once the sampling end signal S12 is asserted at time t₇, the switch SW11 is turned off, and the rise of the voltage V_{C1} stops.

Once the correction start signal S13 is asserted at time t₈, the switch SW22 is turned on, and the voltage V_{C1} of the capacitor C1 drops. The correction end signal S14 is asserted after the first correction time period τ_{1(CMP)} equal to the first time period τ_{1(CMP)} has elapsed.

Next, a configuration example of the timer circuits 470_1 and 470_2 will be described.

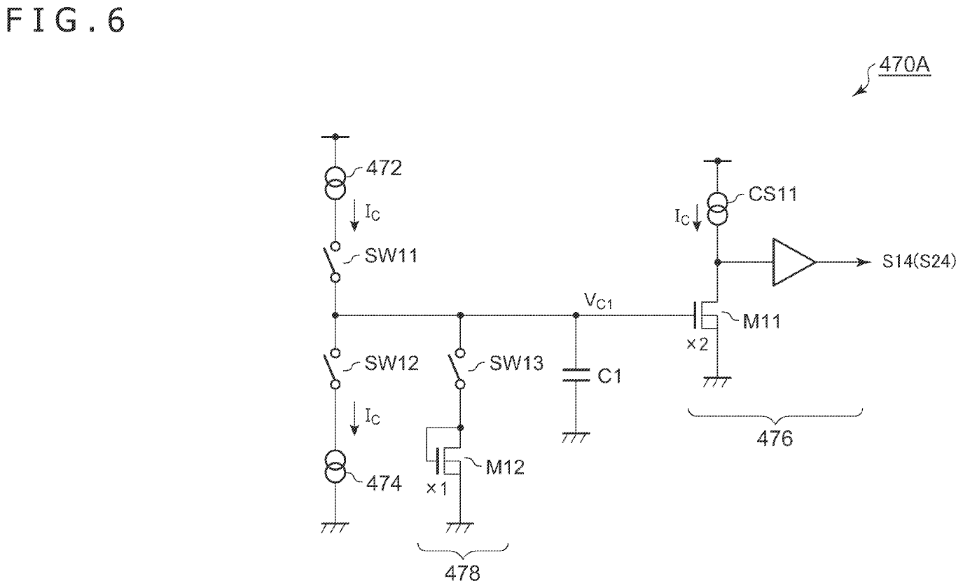

FIG. 6 is a circuit diagram of a specific configuration example (470A) of the timer circuit 470. In the timer circuit 470A, the comparison circuit 476 includes a metal oxide semiconductor (MOS) transistor M11 and a constant current source CS11.

An initialization circuit 478 includes a MOS transistor M12 and a switch SW13. The transistor M12 is a replica of the same type as the MOS transistor M11, and the size of the transistor M11 is twice the size of the transistor M12. The switches SW13 and SW11 are turned on to initialize the capacitor C1. As a result, the capacitor C1 is charged with the initial voltage V_{INIT} corresponding to a threshold voltage V_{GS(th)} of the transistor M11.

During the sampling, the switch SW11 is turned on, and the capacitor voltage V_{C1} rises from the initial voltage V_{INIT} During the timer operation, the switch SW12 is turned on, and the capacitor voltage V_{C1} drops with time. The correction end signal S14 (S24) is asserted when the capacitor voltage V_{C1} drops to the gate threshold voltage V_{GS(th)} of the transistor M11.

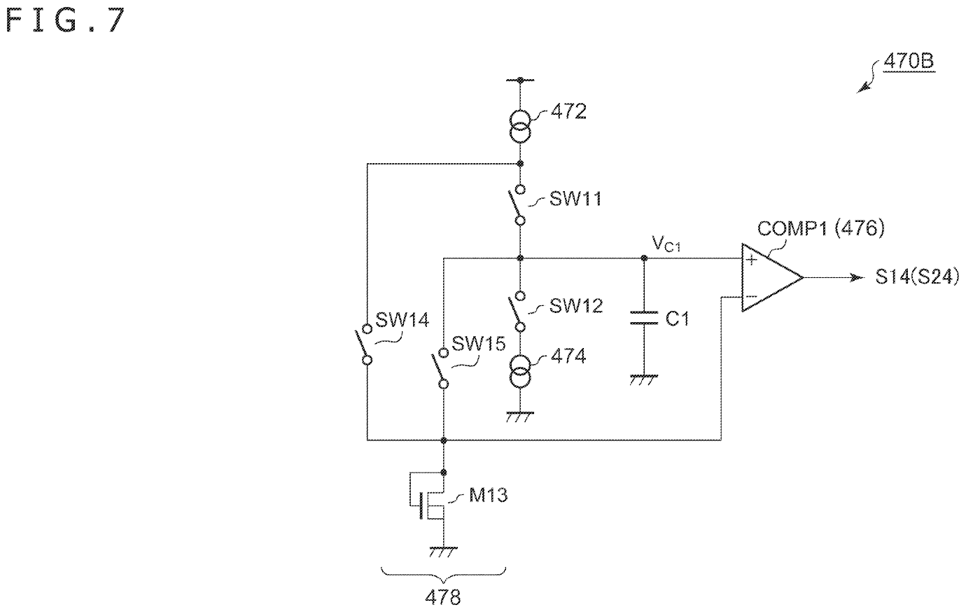

FIG. 7 is a circuit diagram of a specific configuration example (470B) of the timer circuit 470. In the timer circuit 470B, the comparison circuit 476 includes a two-input voltage comparator COMP1.

The initialization circuit 478 includes switches SW14 and SW15 and an impedance element. Although the impedance element in the example is a MOSFET in which the gate and the drain are connected to each other, the impedance element is not limited to this. The impedance element can be an element that causes a constant voltage drop because of a flow of the constant current Ic, and the impedance element may be a resistance or a diode, for example.

The switches SW11 and SW15 are turned on to initialize the capacitor C1. In this case, the initial voltage V_{INIT} corresponding to the gate threshold voltage V_{GS(th)} of the transistor M13 is applied to the capacitor C1.

During the sampling, the switch SW11 is turned on, and the capacitor voltage V_{C1} rises from the initial voltage V_{INIT} During the timer operation, the switch SW12 is turned on, and the capacitor voltage V_{C1} drops with time. During the timer operation, the switch SW14 is turned on, and the threshold voltage V_{TH} corresponding to the gate threshold voltage V_{GS(th)} of the transistor M13 is supplied to the voltage comparator COMP1.

The configuration of FIG. 7 has the following advantage over the configuration of FIG. 6. The initial voltage V_{INIT} and the threshold voltage V_{TH} tend to be offset, and the propagation delay is large in the configuration of FIG. 6. On the other hand, the comparison circuit 476 includes the high-speed voltage comparator COMP1, and the propagation delay can be reduced in the configuration of FIG. 7. In principle, the initial voltage V_{INIT} and the threshold voltage V_{TH} are not offset in the configuration of FIG. 7.

It is preferable that the voltage comparator COMP1 of FIG. 7 can adjust an input offset voltage V_{OFS}. By adjusting the input offset voltage V_{OFS} of the voltage comparator COMP1, the timing of the correction end signals S14 and S24 can slightly be adjusted, and the influence of propagation delay occurred in other paths can be canceled.

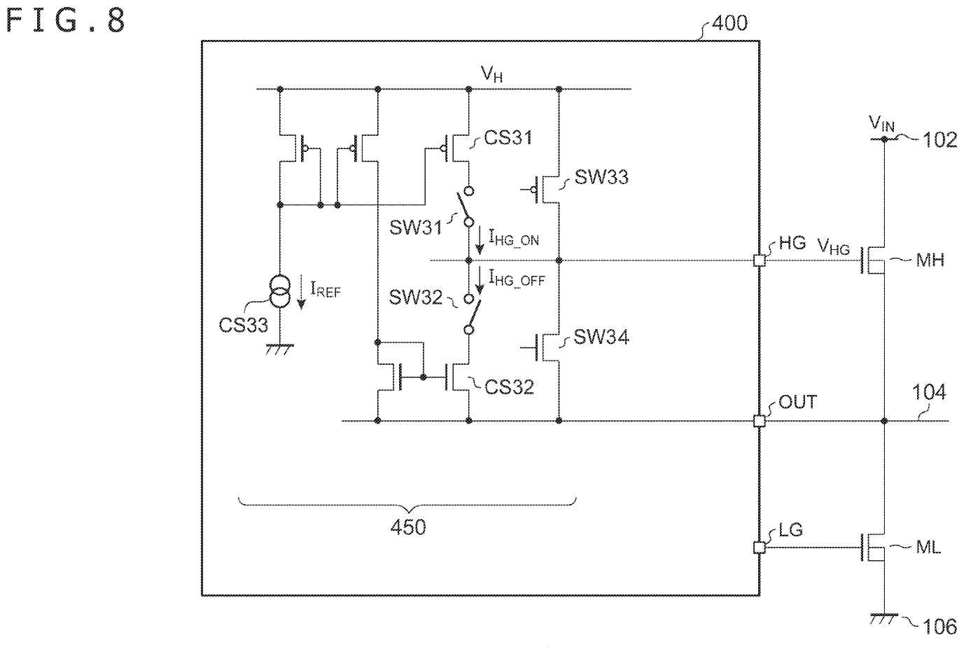

FIG. 8 is a circuit diagram illustrating a configuration example of the high side driver circuit 450. The high side driver circuit 450 includes a source current source CS31, a sink current source CS32, and switches SW31 to SW34.

The source current source CS31 includes a current mirror circuit that replicates a reference current I_{REF} generated by the constant current source CS33. The switch SW31 is turned on in a period in which the on-current I_{HG_ON} needs to be output. Similarly, the sink current source CS32 includes a current mirror circuit that replicates the reference current I_{REF}. The switch SW32 is turned on in a period in which the off-current I_{HG_OFF} needs to be output. According to the configuration, equal amounts of on-current I_{HG_ON} and off-current I_{HG_OFF} can be generated.

The strong on switch SW33 is turned on after the high side transistor MH is fully turned on. The switch SW31 can be turned off after the high side transistor MH is fully turned on.

On the other hand, the strong off switch SW34 is turned on after the high side transistor MH is completely turned off. The switch SW32 can be turned off after the high side transistor MH is turned off.

The configuration of the low side driver circuit 490 can be similar to the configuration of the high side driver circuit 450.

Next, usage of the switching circuit 100 will be described. The switching circuit 100 can suitably be used in a drive circuit of a motor.

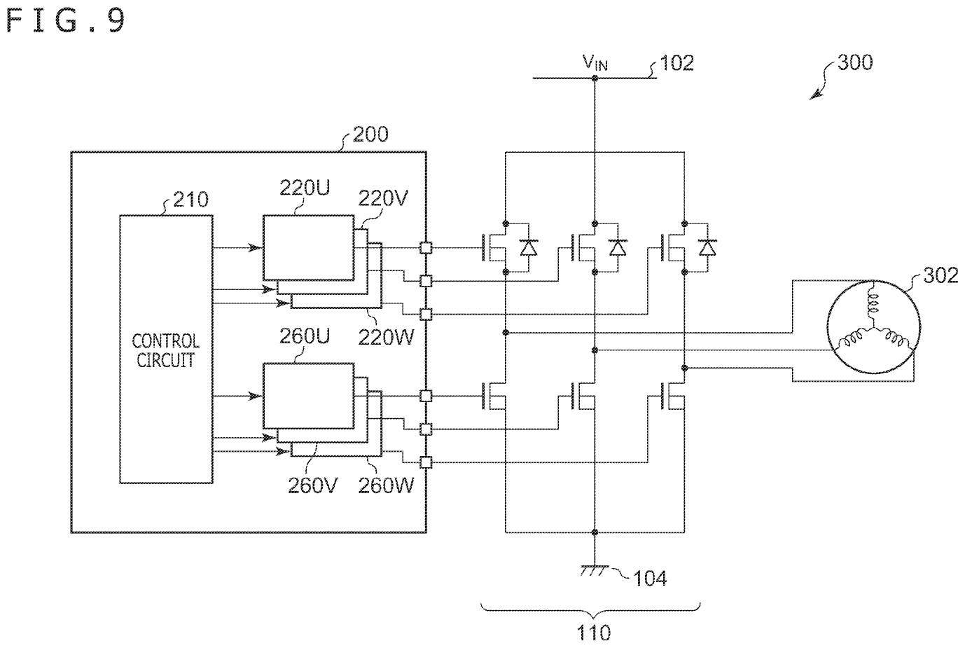

FIG. 9 is a circuit diagram of a motor drive apparatus 300 including the switching circuit 100 according to the embodiment. The motor drive apparatus 300 drives a three-phase motor 302 that is a load, and controls the rotation state.

The motor drive apparatus 300 includes the bridge circuit 110 and a drive circuit 200. The bridge circuit 110 is a three-phase inverter including legs of a U phase, a V phase, and a W phase, and the leg of each phase includes an upper arm and a lower arm.

The drive circuit 200 includes a control circuit 210, high side driver circuits 220U to 220W, and low side driver circuits 260U to 260W. The control circuit 210 generates a control signal for indicating the state of six arms included in the bridge circuit 110, on the basis of the state of the three-phase motor 302 that is a load.

The high side driver circuits 220U to 220W include the architecture of the high side driver circuit 450 described above, and the high side driver circuits 220U to 220W can correct the influence of the error in the duty cycle caused by the dead time.

Although the motor is a three-phase motor in the example here, the motor may be a single-phase motor. In this case, the bridge circuit 110 is an H-bridge circuit.

Next, usage of the motor drive apparatus 300 will be described. The motor drive apparatus 300 can be used to control a spindle motor of a hard disk or to control a lens driving motor of an imaging device. Alternatively, the motor drive apparatus 300 can be used to drive a driving motor of a head of a printer or to drive a paper feed motor.

Alternatively, the motor drive apparatus 300 can be used to drive a motor of an electric car, a hybrid car, or other car.

The embodiment is illustrative, and those skilled in the art will understand that there can be various modifications for the combinations of the constituent elements and the processes and that the modifications are also within the scope of the present disclosure or the present technology. The modifications will be described below.

### (Modification 1)

Although the bridge circuit 110 is a discrete part in the embodiment, the configuration is not limited to this, and the bridge circuit 110 may be integrated into the drive circuit 400.

### (Modification 2)

The upper arm 112 and the lower arm 114 may be insulated gate bipolar transistors (IGBTs).

### (Modification 3)

The switching circuit 100 can be used in apparatuses other than the motor drive apparatus 300. The switching circuit 100 can suitably be used in, for example, a switching regulator (DC/DC converter), various power conversion apparatuses (inverters and converters), a lighting inverter of a discharge lamp, and a digital audio amplifier. Therefore, the switching circuit 100 can be used in consumer products such as electronic devices and home appliances, cars, in-vehicle parts, industrial vehicles, and industrial machines.

The embodiment is illustrative, and those skilled in the art will understand that there can be various modifications for the combinations of the constituent elements and the processes and that the modifications are also within the scope of the present disclosure or the present technology.

What is claimed is:

1. A drive circuit that drives a bridge circuit including a high side transistor connected between a power line and an output line and a low side transistor connected between the output line and a ground line, the drive circuit comprising:
an output sensor that generates an output monitor signal for indicating that an output voltage of the bridge circuit has transitioned to high or transitioned to low;
a correction circuit that receives the output monitor signal and an input signal for giving an instruction for output of the bridge circuit and generates a real drive signal;
a high side driver circuit that drives the high side transistor according to a high side control signal based on the real drive signal; and
a low side driver circuit that drives the low side transistor according to a low side control signal based on the real drive signal, wherein
the correction circuit
measures a first time period that is a time period from a transition of the real drive signal to an on-level to a time when the output monitor signal indicates a transition of the output voltage to high,
measures a second time period that is a time period from a transition of the real drive signal to an off-level to a time when the output monitor signal indicates a transition of the output voltage to low,
changes, in a cycle, the real drive signal to the on-level after the second time period that is measured in a previous cycle has elapsed since a transition of the input signal to an on-level, and
changes the real drive signal to the off-level after the first time period that is measured in the same cycle has elapsed since a transition of the input signal to an off-level.

2. The drive circuit according to claim 1, wherein
the correction circuit includes
a first timer circuit that measures the first time period, and
a second timer circuit that measures the second time period.

3. The drive circuit according to claim 2, wherein
the first timer circuit includes
a first capacitor,
a first charge circuit that charges the first capacitor with a constant current, the first charge circuit being enabled when the real drive signal transitions to the on-level, the first charge circuit being disabled when the output monitor signal indicates the transition of the output voltage to high,
a first discharge circuit that discharges the first capacitor with a same amount of constant current as the first charge circuit, the first discharge circuit being enabled when the input signal transitions to the off-level, and
a first comparison circuit that compares a voltage of the first capacitor and a first threshold voltage corresponding to an initial voltage of the first capacitor and generates a turn-off trigger, and
the correction circuit changes the real drive signal to the off-level in response to the turn-off trigger.

4. The drive circuit according to claim 2, wherein
the second timer circuit includes
a second capacitor,
a second charge circuit that charges the second capacitor with a constant current, the second charge circuit being enabled when the real drive signal transitions to the off-level, the second charge circuit being disabled when the output monitor signal indicates the transition of the output voltage to low,
a second discharge circuit that discharges the second capacitor with a same amount of constant current as the second charge circuit, the second discharge circuit being enabled when the input signal transitions to the on-level, and
a second comparison circuit that compares a voltage of the second capacitor and a second threshold voltage corresponding to an initial voltage of the second capacitor and generates a turn-on trigger, and
the correction circuit changes the real drive signal to the on-level in response to the turn-on trigger.

5. The drive circuit according to claim 3, wherein
the first comparison circuit includes
a first impedance element provided on a path of the constant current generated by the first charge circuit, and
a first voltage comparator,
the first timer circuit applies, prior to start of timer operation, the initial voltage based on a voltage drop of the first impedance element to the first capacitor, and
the first voltage comparator compares the voltage of the first capacitor and the threshold voltage based on the voltage drop of the first impedance element.

6. The drive circuit according to claim 5, wherein
the first voltage comparator is capable of adjusting an input offset voltage.

7. The drive circuit according to claim 5, wherein
the first comparison circuit includes
a first field-effect transistor having a gate connected to the first capacitor, and
a second field-effect transistor that is of a same type as the first field-effect transistor and that has a gate and a drain connected to each other, and,
prior to the start of the timer operation, the timer circuit applies, to the first capacitor, the initial voltage based on a voltage drop of the second field-effect transistor in a state in which the constant current generated by the first charge circuit flows to the second field-effect transistor.

8. The drive circuit according to claim 1, wherein
the high side driver circuit is configured to supply a predetermined amount of on-current to a gate of the high side transistor when the high side control signal is in an on-level, and configured to sink the predetermined amount of off-current from the gate of the high side transistor when the high side control signal is in an off-level.

9. The drive circuit according to claim 1, wherein
the drive circuit is integrated into one semiconductor substrate.

10. A motor drive apparatus comprising:
a bridge circuit including a high side transistor and a low side transistor; and
the drive circuit according to claim 1 that drives the bridge circuit.

11. An electronic device comprising:
a motor; and
the motor drive apparatus according to claim 10 that drives the motor.
